(19) United States
(12) Patent Application Publication
(10) Pub. No.: US 2004/0238692 A1
(43) Pub. Date: Dec. 2, 2004

(54) Hot air balloon vent

(76) Inventor: Phillip Robert Kavanagh, New South Wales (AU)

Correspondence Address: McCarter & English, LLP, Four Stamford Plaza, 107 Elm Street, Stamford, CT, 06460, US

(21) Appl. No.: 10/766,062

(22) Filed: Jan. 28, 2004

Related U.S. Application Data
(63) Continuation of application No. 10/089,969, filed on Aug. 22, 2002, now abandoned.
Application No. 10/089,969 is a 371 of international application No. PCT/AU00/01224, filed on Oct. 9, 2000.

(30) Foreign Application Priority Data
Oct. 8, 1999 (AU) PQ 3324
Oct. 21, 1999 (AU) PQ 3564

(51) Int. Cl. B64D 17/14

(52) U.S. Cl. 244/152

(57) ABSTRACT

A hot air balloon vent for use with a thermal aircraft or hot air balloon is provided. An aperture associated with the aircraft or balloon is generally adapted to be closed by the vent which includes an operculum of a flexible material that is substantially of parachute form. A control mechanism is provided to effect closure of the aperture by extending the operculum laterally or radially. When so moved, the operculum may be extended to its maximum surface area, at which point it covers and seals the aperture. The control mechanism generally includes conjoined contiguous vent control elements that permit the outer perimeter of the operculum to be pulled away from the perimeter edge of the aperture to variably open the aperture.

### TECHNICAL FIELD

The present invention relates in general to venting control means for thermal aircraft, and especially for hot air inflatable balloons, and to thermal aircraft incorporating such venting control means.

### BACKGROUND ART

Thermal aircraft, such as hot air balloons, comprise an aerostat or an envelope having a top opening with a top cap for closing the opening, and a gondola suspended from the bottom of the envelope. During normal flight, the top opening is closed, but can be partially opened during flight for venting of hot air from the envelope for vertical manoeuvring. At the end of the flight, the top opening is fully opened to rapidly deflate the envelope.

Deflation of the envelope is an important factor in the control of the balloon or other thermal aircraft. It is necessary and desirable when the balloon lands to rapidly deflate the balloon so that the envelope will rapidly collapse thus preventing the balloon from being blown across the ground by the wind, which has been the cause of many serious ballooning accidents. In the past, rapid deflation has usually been achieved by means of one or more removable panels attached to the envelope by means of hook and loop fasteners such as “Velcro” or similar fastening means, or by means of a “parachute valve” temporarily closing and being removable from an aperture at the upper end of the balloon envelope.

The invention of the parachute vent or parachute valve for conventional parachutes is generally attributed to Rohulick, U.S. Pat. No. 2,404,659 published in 1946. Rohulick conceived the idea of a parachute wherein the main parachute canopy or umbrella included a relatively small auxiliary umbrella to control the opening of an aperture at the top of the main parachute canopy. This concept was subsequently adapted to the control of hot air balloons by Robert Noirclerc (French Pat. No. 2 253 654—see below) in 1973, and by Tracy Bames in 1974 (not patented). See also U.S. Pat. No. 4,033,527 to Roger Parsons, published in 1976, wherein the adaptation of a parachute valve to hot-air airships is disclosed.

A parachute vent is typically an oversize circular panel manufactured from the same material as that used in the balloon envelope (e.g. high tenacity polyurethane coated ripstop nylon), held in place against the underside of the aperture in the top of the balloon by internal (hot) air pressure. The seal is a suction seal of fabric of the parachute against the fabric of the balloon envelope surrounding the perimeter of the aperture. In effect, the parachute acts as an operculum, and the parachute and associated aperture operate or act as an opercular or operculate valve.

The parachute normally seals and is seated against the balloon aperture, being appropriately centred against the aperture and/or within the balloon envelope by means of a plurality of centralising lines extending between the outer perimeter of the parachute and the inner walls of the envelope. A plurality of shroud lines depend downwardly from the perimeter of the parachute, joined together at a point centrally below the parachute, fitted with a pulley. A parachute activation cord passes through this pulley, tethered at one end to the inner wall or a seamed rib of the envelope towards the lower end thereof, with the other end of the activation cord extending to the operator, or balloon pilot, in the basket below the balloon envelope. In operation, if the pilot wishes to descend or to simply vent the balloon, the pilot pulls the activation cord downwardly, which pulls the parachute downwardly and away from the aperture, venting the balloon envelope to the atmosphere. As the pilot releases the downward pull pressure on the activation cord, the parachute is forced upwards by the internal pressure within the balloon such that the parachute seals against and seals the upper aperture of the balloon.

As the size of the hot air balloons have increased during recent years, the operation of parachute vents have become a problem for all but very heavy pilots. This problem is exacerbated during the balloon landing phase, since the force required to activate or to open the vent is increased during the landing phase, due to pressure from the escaping air which tends to force the parachute operculum vent back up against the aperture.

During the past two decades, numerous attempts have been made to improve the reliability of parachute-type vents or to improve the mechanical advantage in operating same. French Pat. No. 2 253 654 (Noirclerc), published in July 1975 and based on an application filed in France in December 1973, discloses a parachute vent for aerostats—including hot air balloons—wherein the vent is a double vent arrangement comprising a small inner parachute vent coaxially and concentrically aligned within a larger outer parachute vent, which in turn controls the closure of an aperture at the upper end of the envelope of a hot air balloon. The small vent is opened first, followed by the opening of the larger vent for precise and rapid deflation of the envelope.

U.S. Pat. No. 4,651,956 to James Winker et al, granted March 1987, discloses a hot air balloon having a top cap or closure valve which forms both a deflation panel and a manoeuvring port for the balloon. The top cap is releasably secured to the balloon envelope by means of a closure assembly including a fixed member secured to the envelope interior and a releasable member which is firstly secured to the top cap and secondly releasably secured to the fixed member. However, once released it is not possible to re-set the top cap in flight, or to terminate or reverse the deflation process once it has been commenced.

U.S. Pat. No. 4,836,471 to Donald Piccard, granted June 1989, discloses a parachute-type vent for hot air balloons which may be opened by applying force to a pull cord having a series of pulleys whereby the applied force is provided with an improved mechanical advantage. In one embodiment, the closure valve is provided with a reefing line to choke the closure valve radially inwardly to open the balloon aperture for rapid deflation of the balloon. However, again it is not possible to reset the valve in flight or to reverse or terminate the deflation process once it has been commenced.

British patent No. 2260956 in the name of Cameron Balloons Limited (inventor Donald A Cameron), discloses a venting valve for a hot air balloon having a valve member which may be secured to the envelope by a releasable locking mechanism to limit the valve-opening movement of the valve member. In this venting valve, with the valve member secured to the envelope by the locking mechanism, the valve member is prevented from moving clear of the balloon aperture. This is suitable for in-flight venting of the balloon envelope since the valve can be readily opened and closed in flight. For rapid deflation of the balloon envelope, the locking mechanism is released and the valve member moves to a position well clear of the balloon aperture allowing increased outflow of air. However, when the locking mechanism has been released, it is not possible to reset the valve member in place during flight.

Also in recent years, another attempt has been made to improve the parachute vent, by the development of the so-called ‘SuperChute’ in the United Kingdom by Lindstrand Balloons Limited (designed by Per Lindstrand and Simon Forse). As in the case of a conventional parachute vent, the SuperChute comprises a circular panel which seals against the balloon aperture. It may also have shroud lines from its perimeter joined centrally below the circular panel such that it can be operated like a conventional parachute vent. However, it also comprises a control rope attached to the axial centre of the circular panel of the SuperChute (or to a plurality of ropes which extend radially from the centre of the circular panel to the outer perimeter thereof). The SuperChute is also characterised by the rerouting of the parachute valve centring lines back up to the crown of the balloon envelope where they are held in place by an armed release mechanism or locking device which must be “fired” before actuating the rapid deflation mode. Before activation, the SuperChute behaves as a typical pulley-assisted parachute valve either for in-flight venting or for final deflation in moderate wind speeds.

An improved venting control means, known as the ‘SMART VENT’, is disclosed in our earlier Australian Patent No. 669088, which relates to a venting valve or operculum for a thermal aircraft, such as a hot air load-carrying balloon which includes a balloon envelope having a deflation aperture therein. The venting valve is designed to removably cover and seal the aperture and to be opened and/or closed rapidly so as to assist in the control of the balloon, forming both a deflation panel and a manoeuvring port for the balloon. The venting valve is removably and releasably secured to the balloon envelope adjacent the periphery of the valve, and means are provided for controllably and selectively positioning the valve in the aperture for opened and closed dispositions thereof. Separate controls are provided firstly to extend the valve to its maximum surface area, at which point it removably covers and seals the aperture and/or to allow controlled venting of hot air therefrom, and secondly to allow reefing of the valve from the aperture for rapid deflation of the envelope. This provides the pilot with a great deal of control over the flight of the balloon, especially during final landing procedures and especially during such procedures in gusty or windy conditions, contributing significantly to control and safety.

However, whilst vastly superior to previously known venting means, the Smart Vent can still be difficult to use under certain circumstances for lighter-built pilots flying larger sized balloons, or in dusty conditions—such as in central Australia or central Africa —where the presence of dust particles on the surfaces of the balloon and/or the venting valve and its controls, increases the frictional forces on the valve. As indicated above, this effect can be exacerbated during the balloon landing phase, due to the pressure from the escaping air which tends to force the parachute vent back up against the aperture.

### OBJECTS OF THE INVENTION

It is an object of this invention to provide improved venting means for the generation and control of thermal aircraft such as inflatable balloons, and especially hot air balloons.

It is another object of this invention to provide improved venting means for thermal aircraft which go at least some way towards overcoming or at least minimising the prior art problems or limitations outlined above, or for providing a clear alternative choice for thermal aircraft owners or pilots.

It is a further object of this invention to provide improved venting means for thermal aircraft which is universally adaptable for use with any type of thermal aircraft which requires venting of an internal chamber or envelope to the atmosphere.

It is yet another object of this invention to provide improved venting means for thermal aircraft which is relatively simple and inexpensive to manufacture, and which is simple in operation.

It is yet a further object of this invention to provide thermal aircraft which comprise venting means of the type disclosed herein.

Other and further objects of the present invention will become apparent to those skilled in the art upon a study of the following descriptions and accompanying drawings.

### DISCLOSURE OF THE INVENTION

According to one aspect of the invention, there is provided venting means for a thermal aircraft, such as a hot air balloon, said thermal aircraft having an outer envelope for containing a quantity of hot air and an aperture in said envelope at or near its upper end for venting hot air from the envelope, said apparatus being adapted to be temporarily closed or sealed by said venting means, said venting means comprising an operculum of a flexible material and substantially of parachute form adapted to removably cover and seal said aperture, first control means to extend said operculum laterally or radially to its maximum surface area at which point it removably covers and seals the aperture, characterised in that said first control means include conjoined contiguous venting control means which permit the outer perimeter at least of the operculum to be pulled away from the perimeter edge of the aperture to variably open same.

Preferably the operculum or vent panel is attached to the central crown ring of the aperture, either directly or by means of a plurality of centring cords extending from adjacent the outer perimeter edge of the vent panel to the crown ring, or through rings under the crown ring and attached to the top centre of the vent panel. Some embodiments of the venting means, usually for smaller balloons, exclude top centring cords.

Preferably, the operculum or vent panel includes second control means for reefing or to contract or gather said operculum radially or laterally inwardly from or adjacent its outer peripheral edge towards its centre, and axially downwardly away from the aperture towards the centre of the outer envelope to unseal and to expose or open the aperture for rapid deflation of the envelope. Alternatively, the operculum or vent panel may be contracted or gathered to one side of the aperture, and optionally axially downwards towards the interior of the balloon envelope.

The second control means ideally takes the form of a centre pull deflation line connected to the operculum at the bottom or underside centre of the vent panel. Alternatively the deflation line may be connected to the underside of the vent panel at a plurality of arcuately spaced-apart locations on an inner periphery of the vent panel, radially spaced outwardly of the centre of the vent panel but radially spaced inwardly of the outer perimeter of the operculum or vent panel. Preferably, the additional points of attachment to the operculum are at arcuately spaced locations from about one quarter to about half of the radius of the operculum or vent panel.

In a further embodiment, the second control means is operatively connected to the outer perimeter of the vent panel by means of a plurality of drawstrings affixed at symmetrically arcuately spaced locations adjacent the outer perimeter of the vent panel and extending radially inwardly through one or more rings or pulleys affixed to the underside of the vent panel towards the centre of the vent. The first control means allows the vent panel to be fully extended laterally or radially to its maximum surface area to cover and seal the aperture, and the second control means allows for the vent panel to contract or to be gathered radially inwardly from or adjacent its outer peripheral edge towards its centre to unseal and to open the aperture, to permit outflow of air from the interior of the balloon envelope.

The second control means are optional, and some embodiments of the invention —especially for smaller balloons—do not require a separate centre pull deflation line. In this case the parachute vent line of the first control means is used for venting of the balloon during flight and for rapid deflation during final landing of the balloon.

According to another aspect of the present invention there is provided a thermal aircraft, such as a hot air balloon having an outer envelope for containing a quantity of hot air and supporting a load-carrying basket, the envelope having an aperture formed therein at or near its upper end to permit outflow of air from the interior of the envelope, said aperture being adapted to be closed by removable venting means under pressure of air inside the envelope, and a closure assembly for the venting means permitting controlled opening and closing thereof, wherein the venting means comprises an operculum of a flexible material and substantially of parachute form adapted to removably cover and close the aperture, and wherein the closure assembly includes first control means to extend the operculum laterally or radially to its maximum surface area at which point it removably covers and seals said aperture, characterised in that said first control means include conjoined contiguous venting control means which permit the outer perimeter at least of the operculum to be pulled away from the perimeter edge of the aperture to variably open same.

Preferably, the operculum or vent panel of the thermal aircraft also includes second control means for reefing or to contract or gather the operculum radially or laterally away from the edges of the aperture towards its centre or to one side of the aperture, and/or axially downwardly away from the aperture towards the centre of the outer envelope to unseal and to expose or open the aperture for rapid deflation of the envelope, such as in the final landing phase of the balloon or thermal aircraft.

### BRIEF DESCRIPTION OF THE DRAWINGS

The invention will now be described by way of example only and with reference to the accompanying drawing, but it should be appreciated that modifications and variations may be made to the embodiment exemplified without departing from the scope or spirit of the invention.

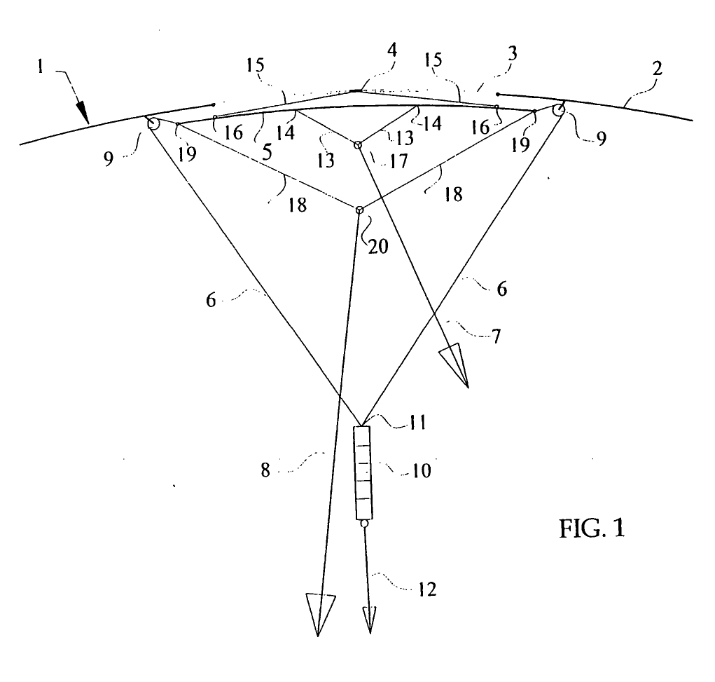

In the accompanying drawing, FIG. 1, there is illustrated a cross-sectional view of an upper portion of a hot air balloon incorporating an improved venting arrangement according to the present invention, with the vent in the closed position.

### BEST MODE OF CARRYING OUT THE INVENTION

The hot air balloon 1 comprises a hot air inflatable balloon or aerostat 2 having an opening or aperture 3 at the upper end of the envelope. A plurality of tapes are affixed at spaced locations about the periphery of the aperture 3, and extending radially inwardly to join a control crown ring 4 as shown in phantom outline in FIG. 1. These serve to contribute to the integral strength and stability of the balloon envelope, and to retain the operculum valve member 5 in place. The structure within the aperture 3 is referred to as a spider.

The aperture 3 is closeable by means of a venting valve member 5. The valve member forms both a deflation panel and a manoeuvring port for the balloon, and is designed to be opened and/or closed rapidly so as to assist in control of the balloon.

The venting valve includes first control means 6 to extend the operculum 5 laterally or radially to its maximum surface area to close the aperture 3, and associated control means 7 in conjunction with the first control means to reef or to contract or gather the operculum to an area of minimum diameter to open the aperture to the outside ambient atmosphere, and second control means 8 acting as a parachute vent line.

The first or reset control means, to extend the operculum 5 to its maximum surface area, or to its maximum diameter, comprises a plurality of control lines 6 attached to the outer perimeter of the valve member 16 at arucately spaced locations and extending radially outwardly from the outer perimeter of the valve member to a pulley or ring 9 attached to the inner surface of the envelope 2 adjacent to but spaced from the aperture 3. The control line passes over the pulley or ring 9 and then extends down to optional weight means 10. A plurality of such control lines and pulleys or rings (e.g. from 12 to 24, depending on the size of the balloon envelope and the number of segments or gores of which it is comprised) are spaced arcuately or radially about the valve member 5. Each said control line 6 passes over its respective pulley or ring 9 and then extends downwardly and inwardly to a central position 11 situated below the valve member 16 at a point on its vertical axis line. Optionally, the control lines 6 are attached to adjustable weight means 10, and then extend via a control reset end to the lower end of the balloon envelope or to the basket of the balloon line 12 down to the balloon pilot.

The first control means includes a parachute vent in conjunction therewith, the operation of which will be described in more detail below.

Preferably, the venting means for the balloon includes second control means for rapid deflation of the balloon, including means to contract or gather the operculum or valve member 5 to an area of minimum diameter within or away from the aperture 3, comprising a plurality of control lines 13 affixed at arcuately spaced intervals 14 about the underside of the valve member 5 for attachment to a control point or claw 17 beneath the underside of the valve member 5. Centring cords 15 extend from the crown ring 4 to arcuately spaced locations 16 about the top side of the valve member 5. A single control line 7 is provided for choking or reefing the valve member 5 radially inwardly towards the centre or to the side of the aperture, and then at least partially down into the centre of the balloon envelope.

When the pilot wants to rapidly vent or to empty hot air from the balloon envelope 2, as in the final landing approach operation, he simply pulls down on the control line 7, which causes the operculum or valve member 5 to gather radially inwardly for rapid venting.

In this embodiment, the operculum vent panel 5 is pulled down into the balloon, causing the vent panel to form a vertical plume in the centre of the vent aperture 3 and extending down into the interior of the balloon. The vent aperture 3 is almost completely uncovered.

The first control means or reset control means 6 include parachute shroud lines 18 conjoined as at 19, which corresponds substantially with the outer peripheral edge of the vent panel 5. The shroud lines 18 are affixed arucately spaced intervals 19 about the peripheral edge of the vent panel 5 and extend inwardly beneath the underside of the vent panel or valve member 5 for attachment to a central point or claw 20. A single control line 8 is provided for venting of hot air from the balloon during flight, or in some cases for rapid deflation, such as in the final landing phase of the balloon or thermal aircraft.

This embodiment of the invention of a balloon vent having first control means in the form of reset cords for extending the vent panel to its full diameter, ideally with one cord per gore, with parachute vent means in conjunction with the reset control means including part or full perimeter parachute shroud lines attached to the underside of the operculum preferably and per gore; for venting during flight; and second control means in the form of a centre pull deflation line attached centre pull shroud lines connected to the underside of the operculum valve, one per gore.

The upper centring cords are preferred but are optional. Ideally they extend radially from the crown ring to adjacent the outer edge of the operculum vent panel, preferably one per gore, but at least a total of four. The upper centring cords may optionally be fitted, preferably one per gore but at least a total of four. In other embodiments the upper centring cords are absent and the top centre of the vent panel is attached to the underside of the central crown ring.

The centre pull shroud lines on the underside of the vent panel are also optional, with a further option being the centre pull deflation line attached directly to the centre of the underside of the vent panel. A third option is to have a pulley or ring drawstring option to allow the panel to contract or to be gathered radially inwardly from or adjacent its outer peripheral edge towards its centre.

Preferably, stops are located on each reset line and against the pulleys which are spaced outwardly from the edge of the vent are optional. Further, an alternative to the pulleys is the use of rings, as is known in the balloon manufacturing art.

The weight(s) on the reset line are optional, but if present they can be varied according to use/user requirements, but ideally are sufficient to main some horizontal tension in the envelope fabric adjacent to the edge of the vent.

In use, the centre pull deflation line is only used for final deflation. All in flight venting and intermediate landings are carried out using the parachute vent, which in practise has been shown to be more effective than previously available parachute vents. The reset line is only used in practice to adjust the vent during or immediately after inflation, or to maintain the integrity of the vent seal during flights in extreme turbulence.

With the valving arrangement of the present invention, the balloon envelope empties of hot air in about 60% of the time it takes for a parachute vent of the same size. The other main advantage is that after the vent has been actuated for deflation, should the pilot change his mind (e.g. because of adverse landing conditions), the vent can be reset halfway through the landing, enabling the balloon to continue in flight. Another advantage is that when the balloon is being inflated before a flight, the vent of the present invention is easier to reset than a standard parachute vent. Preferably, the vent panel or valve member 5 is fitted to the balloon aperture and held temporarily in the required orientation or position during inflation by means of a plurality of ‘Velcro’ tabs or similar self-fastening material.

Thus the present invention provides for infinite control of the venting valve or operculum, repeated opening and closing thereof being possible during flight operation for manoeuvring or deflation of the balloon. This provides the pilot with a great deal of control over the flight of the balloon, especially during final landing procedures and especially during such procedures in gusty or windy conditions, contributing significantly to control and safety.

Although exemplary embodiments of the present invention have been shown and described, it will be appreciated by those having ordinary skill in the art that a number of changes, modifications or alterations to the invention herein may be made, none of which depart from the spirit of the present invention. All such changes, modifications and alterations should therefore be seen as being within the scope of the present invention.

It should be appreciated that the present invention provides a substantial advance in the generation and control of thermal aircraft, such as hot air balloons, providing all of the herein described advantages without incurring any relative disadvantage.

1. A thermal aircraft having an outer envelope for containing a quantity of hot air and supporting a load-carrying basket, the envelope having a aperture formed therein at or near its upper end to permit outflow of air from the interior of the envelope, said aperture being adapted to be closed by removable venting means under pressure of air inside the envelope, and a closure assembly for the venting means permitting controlled opening and closing thereof, wherein the venting means comprises an operculum of a flexible material and substantially of parachute form adapted to removably cover and close the said aperture, and wherein the closure assembly includes first control means to extend the operculum laterally or radially to its maximum surface area at which point it removably covers and seals said aperture, characterised in that said first control means includes conjoined contiguous venting control means which permit the outer perimeter at least of the operculum to be pulled away from the perimeter edge of the aperture to variably open same.

2. A hot air balloon having an outer envelope for containing a quantity of hot air and supporting a load carrying basket, the envelope having an aperture formed therein at or near its upper end to permit outflow of air from the interior of the envelope, said aperture being adapted to be closed by removable venting means under pressure of air inside the envelope, and a closure assembly for the venting means permitting controlled opening and closing thereof, wherein the venting means comprises an operculum of a flexible material and substantially of parachute form adapted to removably cover and close the said aperture, and wherein the closure assembly includes first control means to extend the operculum laterally or radially to its maximum surface area at which point it removably covers and seals said aperture, characterised in that said first control means includes conjoined contiguous venting control means which permit the outer perimeter at least of the operculum to be pulled away from the perimeter edge of the aperture to variably open same.

3. A hot air balloon according to claim 2, wherein the venting means includes second control means for reefing or to contract or gather said operculum radially or laterally inwardly from or adjacent its outer peripheral edge towards its centre, and axially downwardly away from the aperture towards the centre of the outer envelope to unseal and to expose or open the aperture for rapid deflation of the envelope.

4. A hot air balloon according to claim 3, wherein the second control means comprises a centre pull deflation line connected to the underside centre of the operculum.

5. A hot air balloon according to claim 2, wherein the second control means comprises a deflation line connected to the underside of the vent panel at a plurality of arcuately spaced-apart locations on an inner periphery of the underside of the vent panel, radially spaced outwardly from the centre of the vent panel.

6. A hot air balloon according to claim 2 wherein the second control means comprises a deflation line connected to the outer perimeter of the vent panel by means of a plurality of drawstrings affixed at symmetrically arcuately spaced locations adjacent the outer perimeter of the vent panel and extending radially inwardly to the underside centre of the vent.

7. Venting means for a thermal aircraft, such as a hot air balloon, said thermal aircraft having an outer envelope for containing a quantity of hot air and an aperture in said envelope at or near its upper end for venting hot air from the envelope, said aperture being adapted to be temporarily closed or sealed by said venting means, said venting means comprising an operculum of a flexible material and substantially of parachute form adapted to removably cover and seal said aperture, first control means to extend said operculum laterally or radially to its maximum surface area at which point it removably covers and seals the aperture, characterised in that said first control means include conjoined contiguous venting control means which permit the outer perimeter at least of the operculum to be pulled away from the perimeter edge of the aperture to variably open same.
